(19) United States
(12) Patent Application Publication
(10) Pub. No.: US 2008/0226520 A1
(43) Pub. Date: Sep. 18, 2008

(54) Airlift Loop Reactor without the Need for External Gases

(75) Inventors: Dehua Liu, Beijing (CN); Wei Du, Beijing (CN); Lilin Li, Beijing (CN)

Correspondence Address: MICHAEL BEST & FRIEDRICH LLP, 100 E WISCONSIN AVENUE, Suite 3300, MILWAUKEE, WI, 53202, US

(73) Assignee: TSINGHUA UNIVERSITY, Beijing (CN)

(21) Appl. No.: 11/914,793

(22) PCT Filed: May 17, 2006
(86) PCT No.: PCT/CN06/01006

§ 371 Date: Jun. 6, 2008

(30) Foreign Application Priority Data
May 20, 2005 (CN) 200510070863.7

(51) Int. Cl. B01J 19/00

(52) U.S. Cl. 422/234

(57) ABSTRACT

This invention provides an airlift loop reactor without the need for external gases, which comprises main reactor (1), gas circulation line (2), gas punip (3), jacket (4), gas inlet (5), gas outlet (6), flow guider (7), gas flowmeter (8), feed inlet (9) and discharge opening (10). It is characterized by: connecting the gas outlet (6) on top of the airlift loop reactor to the gas inlet (5) at the bottom of the reactor, and installing the gas pump (3) in gas circulation line (2), hence directly using the internal gases as the circulation impetus, so that gases are directed by the gas circulation line (2) back to the bottom of the reactor after flowing out from the top of the reactor and then re-ejected into the reactor by the gas pump (3) and used as circulation impetus again. Compared to common airlift loop reactors which use external gases as the impetus; the airlift loop reactor of the present invention effectively reduces the cost of using external gases and hence diminishes production costs. Therefore, it has very good prospects for industrial application.

### TECHNICAL FIELD

This invention relates to biochemical and fermentation industries. In particular, it provides an airlift loop reactor without the need for external gases.

### BACKGROUND ART

An airlift loop reactor is a biological reactor which uses gases as the impetus to realize the mix and circulation of liquids. Since it is simple in structure, easy to amplify, excellent in mass and heat transfer, low in energy consumption and small in damages to cells, airlift loop reactors are more and more widely applied in biochemical and fermentation industries.

Current airlift loop reactors, which are widely used in industries, use external gases supplied from the bottom of the reactors as impetus. The gases are discharged after flowing up through the reactors. This invention proposes directly utilizing the internal gases as the impetus for the circulation of liquids inside the reactor, hence effectively reduces the cost of external gases and diminishes the production costs. Additionally, using the gases from inside makes the reaction system a closed structure, therefore effectively reducing the loss of raw materials of the reaction.

### DISCLOSURE OF THE INVENTION

The object of the present invention is to provide an airlift loop reactor without the need for external gases.

The reactor of the present invention comprises: main reactor, gas circulation line, gas pump, jacket, gas inlet, gas outlet, flow guider, gas flowmeter, feed inlet and discharge opening.

Specifically, the present invention improves common airlift loop reactors by linking the gas outlet on top of the reactors to the gas inlet at bottom of the reactor, while installing a gas pump in the gas circulation line, hence directly using gases inside the reaction system as the impetus for the circulation. Gases are directed by the gas circulation line back to the bottom of the reactor after flowing out from the top of the reactor, re-ejected into the reactor by the gas pump and used as circulation impetus again.

Gases that could be used as the circulation impetus in this invention include: gases generated during the reaction, gases participated in the reaction and volatile components.

If the circulation impetus gases are generated during the reaction, then a by-pass gas line, with a one-way valve installed on it to adjust the pressure, could be attached on the gas circulation line.

Comparing to traditional airlift loop reactors using external gases as the impetus, using internal gases as the circulation impetus effectively reduces the costs of external gases and the production cost, also the loss of raw materials of the reaction is reduced. The reactor of the present invention is applicable for any reaction system that has gases (including gases participated in reaction or gases generated during reaction or with existence of volatile components) in it, such as biochemical reactors and enzyme reactors, including airlift loop reactors used for wastewater treatments and other environmental protection projects.

In particular, the present invention involves an airlift loop reactor for preparing biodiesel through the transesterification reaction between animal and plant oils and methanol under the catalysis of lipase, wherein volatilized methanol serves as the impetus for circulation of liquids in the reactor. This invention effectively reduces the consumption of external gases and therefore has significant economic implications and good prospects for industrial applications.

### BRIEF DESCRIPTION OF THE DRAWINGS

FIG. 1 shows the structure of an airlift loop reactor of the present invention.

FIG. 2 shows the structure of another airlift loop reactor of the present invention.

FIG. 3 shows the partial enlarged view and bottom profile of an airlift loop reactor of the present invention.

### BEST MODE FOR CARRYING OUT THE INVENTION

Below is a further explanation on working principles and concrete structures of the airlift loop reactor of the present invention with reference to the attached figures.

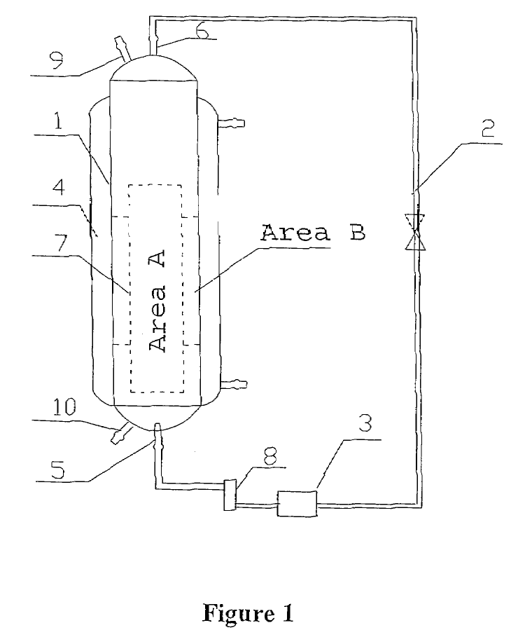

As shown in FIG. 1, the reactor of the present invention mainly comprises: main reactor 1, gas circulation line 2, gas pump 3, jacket 4, gas inlet 5, gas outlet 6, flow guider 7, gas flowmeter 8, feed inlet 9 and discharge opening 10. The upper and lower ends of the gas circulation line 2, in which a gas pump 3 is installed, respectively connect to the top and bottom of the reactor Gases are directed by the gas circulation line 2 back to the bottom of the reactor after flowing out from the top of the reactor, and re-ejected into the reactor by the gas pump 3 and used as circulation impetus again.

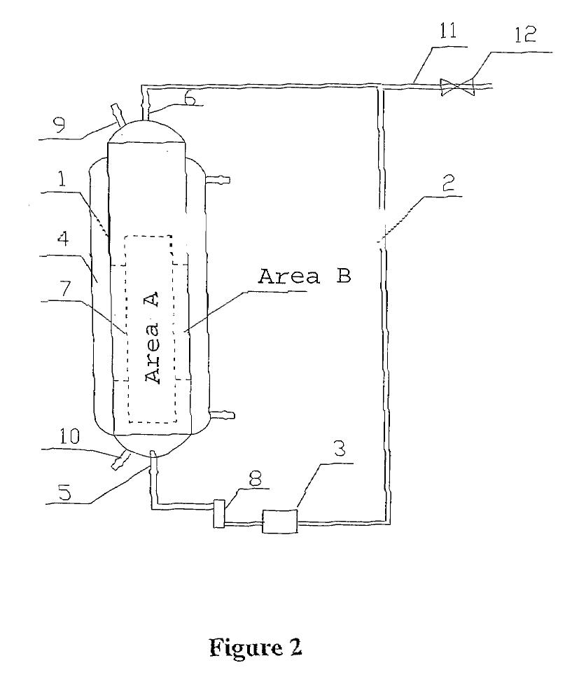

FIG. 2 shows another embodiment of this invention, wherein continuously generated gases during the reaction are used as the circulation impetus. A by-pass gas line 11, with a one-way valve 12 installed on it to adjust the pressure, is attached on the gas circulation line 2.

### EXAMPLE

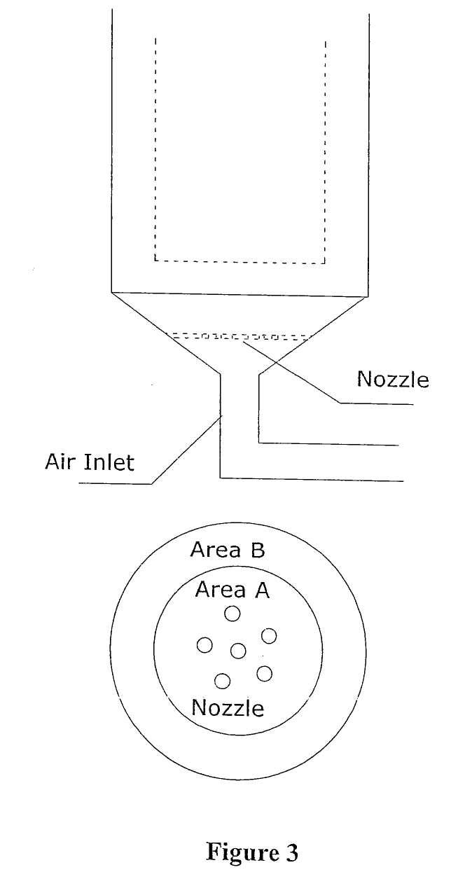

As an example of the present invention, an airlift loop reactor without the need for external gases was provided, as shown in FIG. 1 and FIG. 3. This reactor, with a height of 1.2 m and a height-diameter ratio of 6.7, had a flow guider 7 in it. The flow guider 7 had a diameter of 110 mm and a height of 600 nm mi. The flow guider separated the reactor into a central flow area (area A) and a circular flow area (area B) (as shown in FIG. 3). Six nozzles were uniformly distributed on the circular cross section of area A at the bottom of the reactor. This reactor can be used as an airlift enzyme reactor, to prepare biodiesel through transesterification reaction between animal and plant oils and methanol in the presence of lipase. This reaction system contained volatile liquid methanol, and the vacuum level was controlled by gas pump, using volatilized methanol gas as the impetus for the circulation of liquids inside the reactor. This loop reactor can achieve the same mixing effects as using external gases as the circulation impetus.

Compared to common loop reactors with external gases injected, the airlift loop reactor with no external gases effectively reduces the consumption of external gases, and therefore has significant economic implications and good prospects for industrial applications.

1. An airlift loop reactor that does not need external gases, comprising: a main reactor (1), a gas circulation line (2), a gas pump (3), a jacket (4), a gas inlet (5), a gas outlet (6), a flow guider (7), a gas flowmeter (8), a feed inlet (9) and a discharge opening (10),
wherein the gas outlet (6) is disposed on top of the airlift loop reactor and is connected to the gas inlet (5) disposed at the bottom of the reactor, and
wherein the gas pump (3) is installed in the gas circulation line (2), thereby directly using the internal gases as the circulation impetus, so that gases are directed by the gas circulation line (2) back to the bottom of the reactor after flowing out from the top of the reactor and then are re-injected into the reactor by the gas pump (3) and are again used as the impetus for liquid circulation.

2. The reactor as claimed in claim 1, wherein one or more gases selected from the following group are used as circulation impetus: gases generated during the reaction, gases participated in the reactions and volatile components.

3. The reactor as claimed in claim 1 further comprising a by-pass gas line (11) having a one-way valve (12) to adjust the pressure and, wherein the gas circulation line (2) is connected to the by-pass gas line (11).

4. The reactor as claimed in claim 1, wherein the reactor is configured to be used in the transesterification reaction between animal and plant oils and methanol in the presence of lipase.

5. The reactor as claimed in claim 4, wherein the reactor is configured such that volatile components in the reaction system are directly used as the impetus for liquid circulation.

6. An airlift loop reactor that does not need external gases, comprising: a main reactor (1), a gas circulation line (2), a gas pump (3), a jacket (4), a gas inlet (5), a gas outlet (6), a flow guider (7), a gas flowmeter (8), a feed inlet (9) and a discharge opening (10),
wherein the gas circulation line (2) is connected to a by-pass gas line (11), on which a one-way valve (12) is installed to adjust the pressure, and
wherein the gas outlet (6) is on top of the airlift loop reactor and is connected to the gas inlet (5) at the bottom of the reactor, and the gas pump (3) is installed in the gas circulation line (2), thereby directly using the internal gas as the circulation impetus, so that gases are directed by the gas circulation line (2) back to the bottom of the reactor after flowing out from the top of the reactor, re-injected into the reactor by the gas pump (3) and are again used as the circulation impetus.

7. The reactor as claimed in claim 2, further comprising: a by-pass gas line (11) having a one-way valve (12) to adjust the pressure, and wherein the gas circulation line (2) is connected to the by-pass gas line (11).
